(19) United States
(12) Patent Application Publication
(10) Pub. No.: US 2011/0231304 A1
(43) Pub. Date: Sep. 22, 2011

(54) SECURE METHOD AND APPARATUS FOR REMOTE FUNDING OF CURRENT PAYMENT ACCOUNTS

(75) Inventor: Patrice Peyret, Hillsborough, CA (US)

(73) Assignee: Plastyc, Inc., New York, NY (US)

(21) Appl. No.: 13/035,990

(22) Filed: Mar. 23, 2011

Related U.S. Application Data
(60) Provisional application No. 61/309,825, filed on Mar. 2, 2010.

(51) Int. Cl. G06Q 40/00

(52) U.S. Cl. 705/39

(57) ABSTRACT

A funding method and apparatus between a monetary account holder and a remote cash provider allows the cash provider to fulfill the request for funding received from the account holder through ordinary electronic communication means by redeeming a load voucher against cash into the account of the requester, without the need for the account holder to share any identification of his/her account with the cash provider and without the cash provider having to share any identification of the load voucher with the account holder. The account holder initiates a request for funding by logging into his/her online monetary account and by providing the email address and/or phone number of the solicited cash provider. The cash provider receives a funding request message including either a printable or displayable cash load voucher, or including a link to a data entry form where he/she will be able to input the identifier of a load voucher obtained locally from a distributor of vouchers of the background art. The cash load voucher identifier or the link included in the message sent to the cash provider are uniquely derived from the identity of the account to be funded through the use of a one-way function, thus allowing the cash provider to redeem his/her voucher into the correct account without explicit transmission of the account details.

### FIELD OF THE INVENTION

The present invention relates to current payment accounts, and in particular prepaid cards, which can be re-loaded with cash through retail networks. In particular, the present invention relates to a double-blind digital communication protocol and supporting computer systems allowing an accountholder to request funding from a remote cash provider, and the remote cash provider to supply such funding to the accountholder without exposing the remote cash provider to the identification number of the account to be funded, and without exposing the accountholder to the identification number of the cash load voucher used by the remote cash provider.

### DESCRIPTION OF RELATED ART

Cash-load networks allowing consumers to deposit cash into a current payment accounts like prepaid payment cards are commonplace, allowing cardholders to add funds to their card from time to time with cash tips and other cash hand outs. Such cash load networks fall into two broad categories:

“Card Present” systems, where the accountholder must bring the card linked to the account together with the cash at the load location. Commercial examples of such systems include Visa's ReadyLink, MoneyGram, Western Union.

“Card Non Present” systems where the accountholder needs not bring a card at the load location. In such systems, the cash is typically used to purchase a paper-based loading voucher, such voucher being typically imprinted with a unique identifier number and being later redeemable into the card through a phone or computer system. Commercial examples of such system are Green Dot Corporations' MoneyPaks or PayNearMe's printed slips.

Card non-present cash-to-card load services can in theory let a person other than the cardholder fund a card, since the person buying the redeemable loading voucher with cash does not need the card at the time of purchase. This can be desirable in circumstances where the cash provider is a parent supporting a student cardholder living on a distant campus, or is sending money to help a friend. In practice however, such a funding arrangement between a cardholder and a remote cash provider would be prone to theft, loss or fraud, since it would require either the cardholder to supply his card number to the remote cash provider, or the remote cash provider to provide the voucher number to the cardholder, for redemption of the voucher into the card by respectively the cash provider or the cardholder. For example, the card number could be intercepted by a third party during its transmission, exposing the user to misuse of his payment card by that third party. The card number could also be used by the cash provider without knowledge of the cardholder for subsequent payment transactions. Similarly, the voucher number could be intercepted by a third party during its transmission, as a first step for such third party to perpetrate a “man in the middle” attack and also attempt to capture the card number by posing as the frustrated party to either of the original parties to the transaction.

U.S. Pat. Nos. 6,227,447 and 6,341,724 to Campisano, U.S. Pat. No. 7,815,107 to Kingsboroúgh and al., US patent application publication 2003/0061167 to Mann, III et al., all incorporated herein by reference, teach various aliasing methods for letting an account holder spend money or obtain rewards at a Point of Sale without revealing his/her account number. All the methods described in the referenced prior art relate to full-amount or discounted-amount spending transactions by the account holder, not to funding transactions by a third party other than the account holder.

In theory, the remote cash provider and the cardholder could limit the risk of exchanging the card or cash voucher information by either providing the information in person, during a face to face meeting, which goes contrary to original intent of conducting a remote funding transaction. The remote cash provider and the cardholder could also set up some secure digital communication channel by using encryption and digital signatures techniques between themselves, but such system are highly impractical and almost never used by consumers.

There is thus a need for, and it would be advantageous to have, a secure method and apparatuses enabling a current account holder and a remote cash provider to cooperate via ordinary and un-secure means of communication such as electronic mail or mobile phone text messages to allow the remote cash provider to load money into the account of the accountholder without exposing the account or associated card number to the cash provider nor exposing of the cash voucher number to the current account holder.

### BRIEF SUMMARY OF THE INVENTION

The present invention seeks to provide a method and apparatuses for letting a first person, being a cash provider, load money into the current payment account held by a second person, where the first person and second person may not be able to exchange information by meeting face to face or by establishing secure means of electronic communication between themselves.

In its broadest sense, the present invention allows a current account holder to send a funding request to a remote cash providing person through email or mobile text message, without including any identification data related to the account to be funded in said message, and allows the cash provider person to fulfill the received request by either (a) keying the identification number of a reload voucher purchased from a retail location, in a single-use computer-generated entry form linked to the received email or text message or (b) if the email or text message already contains a unique voucher number, present a printed or machine-readable copy of said email or text message to a retail location, together with the cash expected for the payment.

There is provided, in accordance to a first preferred embodiment of the present invention, a computer-assisted transaction method between the holder of a current account and the purchaser of a cash load voucher, the transaction method includes:

Generating a unique Uniform Resource Identifier derived from the verified accountholder's identity and from the specific accountholder's request for funds via a one-way transformation, i.e. a method that is computationally difficult to reverse;

Generating a single-use data entry form with at least one field suitable for entering a load voucher number, and locating such form at said Uniform Resource Identifier;

Sending a first electronic message to the prospective load voucher purchaser designated by the accountholder, where the message includes the said Uniform Resource Identifier and an invitation to go and purchase a load voucher from a choice of neighboring retail locations selling such vouchers;

Upon detection of the entry of a valid load voucher number in the data entry form located at the Uniform Resource Identifier, assemble a second electronic message including said voucher number and the accountholder's account number, sending such second message to a voucher redemption computer system capable of effecting the adjustment of the account balance by the amount associated with the designated voucher.

There is also provided, according to the first preferred embodiment of the present invention, a transaction system that includes a first computer server containing and managing accountholder information, programmed to generate unique data entry forms, to store such forms in Internet-retrievable pages at unique URIs, to assemble electronic messages including such URIs, to send such electronic messages to designated recipients upon request from accountholders, to collect unique card load voucher identification data entered by recipients in the data entry forms at the unique URIs, and to transmit such voucher identification data to a second computer server programmed to verify the validity of such data and to assemble corresponding account balance update request messages in a format suitable for an ensemble of computer servers programmed to process account maintenance transactions.

There is provided, in accordance to a second preferred embodiment of the present invention, a computer-assisted transaction method between the holder of a current account and the payer of a cash load voucher, the transaction method includes:

Generating a unique cash load voucher derived from or associated with the verified accountholder's identity and optionally from the specific accountholder's request for funds, via a one-way transformation, i.e. a method that is computationally difficult to reverse. By way of example, the cash load voucher can be a series of alphanumeric characters, or a graphical one-dimensional or two-dimensional bar code;

Assembling and sending a first electronic message containing such cash load voucher to the prospective funds provider via means such as electronic mail or mobile messaging;

Inviting the recipient of such message to go to a choice of suitable neighboring cash load locations with a machine-readable copy of the voucher to redeem the load voucher against the desired amount of cash. By way of example, the machine readable copy of the load voucher can be a simple paper copy obtained from having printed the electronic mail, or a mobile device such as a phone or tablet capable of displaying a bar-coded version of the voucher or capable of transmitting the voucher via wireless transmission means to a terminal;

Upon the redemption of the load voucher against the required amount of cash, as completed at a suitably programmed computer terminal located at the cash load location, assemble a second electronic message including said voucher number, sending such second message to a voucher redemption computer system capable of effecting the adjustment of the account balance by the amount associated with the designated voucher.

There is also provided, according to the second preferred embodiment of the present invention, a transaction system that includes (a) a first computer server containing and managing accountholder information, programmed to assemble electronic messages including a unique cash load voucher identifier for each cash load request initiated by an accountholder, to send such electronic messages to designated recipients upon request from accountholders, and (b) a second computer server programmed to receive and verify electronic messages from terminals located at multiple cash load locations indicating that cash load vouchers have been redeemed, and to assemble corresponding account balance update request messages in a format suitable for an ensemble of computer servers programmed to process account maintenance transactions.

### BRIEF DESCRIPTION OF SEVERAL VIEWS OF THE DRAWINGS

The present invention will be understood and appreciated more fully from the following detailed description, taken in conjunction with the drawings in which:

FIG. 1 is a simplified block diagram describing a typical account loading of the background art where the accountholder and the cash provider are one and the same person, and where the redemption of the load voucher is carried out via a voucher holder interface server separate from the accountholder management server.

FIG. 2 is a simplified block diagram describing a typical card loading of the background art where the accountholder and the cash provider are one and the same person, but where the operator of the voucher system has cooperated with the operator of the account system to allow the redemption of the load voucher to be carried out via a the same account holder management server otherwise used by the accountholder to manage other functions than the loading of vouchers.

FIG. 3 is a simplified block diagram of the background art describing the problem solved by the present invention, when the accountholder and the cash provider are two distinct persons, and where the redemption of the load voucher cannot take place without either the voucher purchaser being given the account identification number, or the account holder being given the voucher identification number, even if each of them has access to a separate interface for redeeming the voucher.

FIG. 4 is a simplified block diagram showing a first preferred embodiment of the system and method of the present invention as it involves (a) the sending of a funding request message from the accountholder to the cash provider, including a unique Uniform Resource Identifier, prompting the cash provider to purchase a load voucher at a merchant to fulfill the funding requirement, and (b) the display of a single-use voucher redemption window located at the unique URI to the cash provider, allowing the redemption of the purchased voucher.

FIG. 5 is a simplified flowchart describing the operation of an account funding system constructed according to a first preferred embodiment of the present invention.

FIG. 6 is a simplified block diagram showing a first preferred computer apparatus embodying the present invention.

FIG. 7 is a simplified block diagram showing a second preferred embodiment of the system and method of the present invention as it involves (a) the sending of a funding request message from the accountholder to the cash provider, including a unique Cash Load Voucher, prompting the cash provider to bring a machine-readable version of said Cash Load Voucher to a suitable location where it can be redeemed in cash to fulfill the funding requirement, and (b) the redemption of the Cash Voucher at said location against cash, resulting in the loading of funds in the account of the requester.

FIG. 8 is a simplified flowchart describing the operation of an account funding system constructed according to a second preferred embodiment of the present invention.

FIG. 9 is a simplified block diagram showing a second preferred computer apparatus embodying the present invention.

FIG. 10 is a list of the main data elements exchanged electronically between the computer systems according to the first and second preferred embodiments of the present invention.

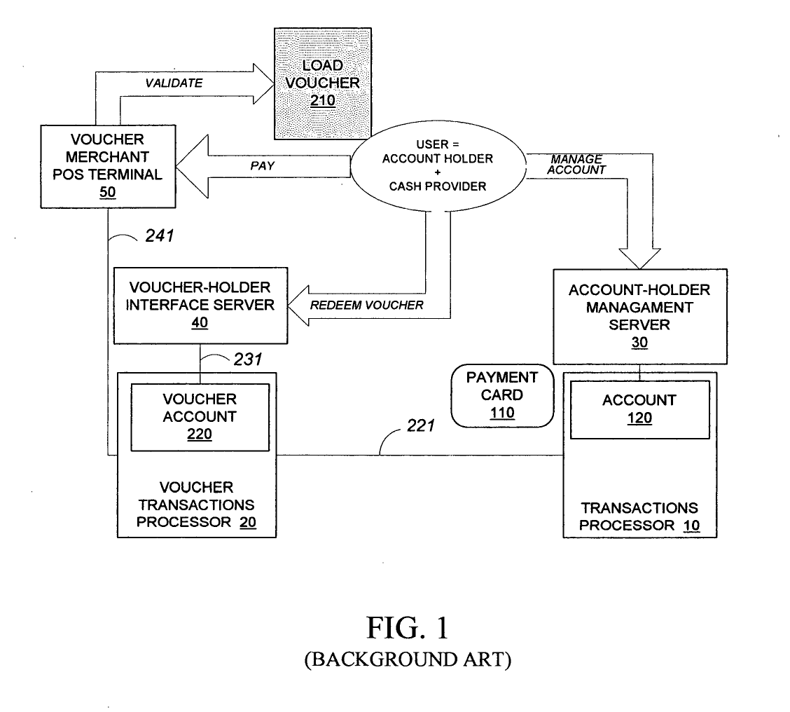

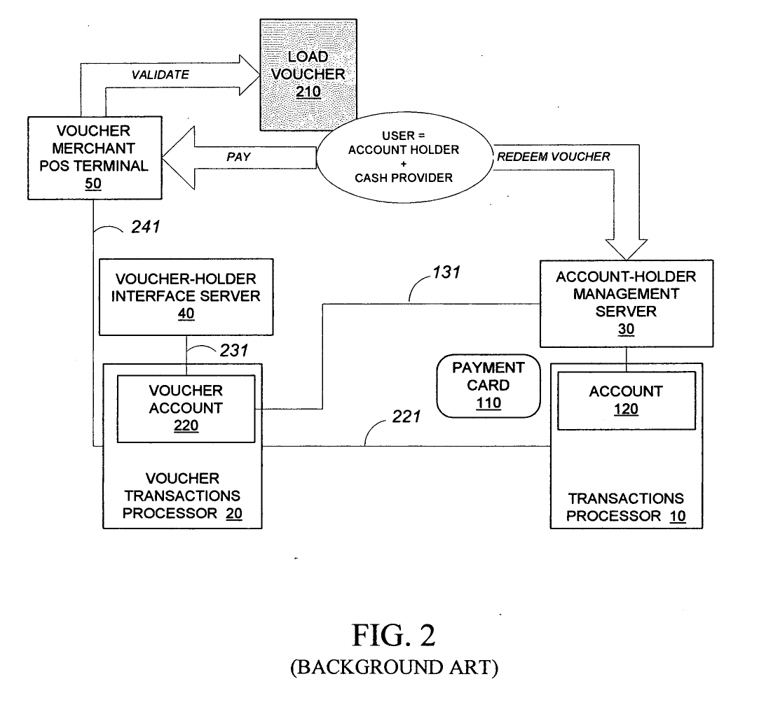

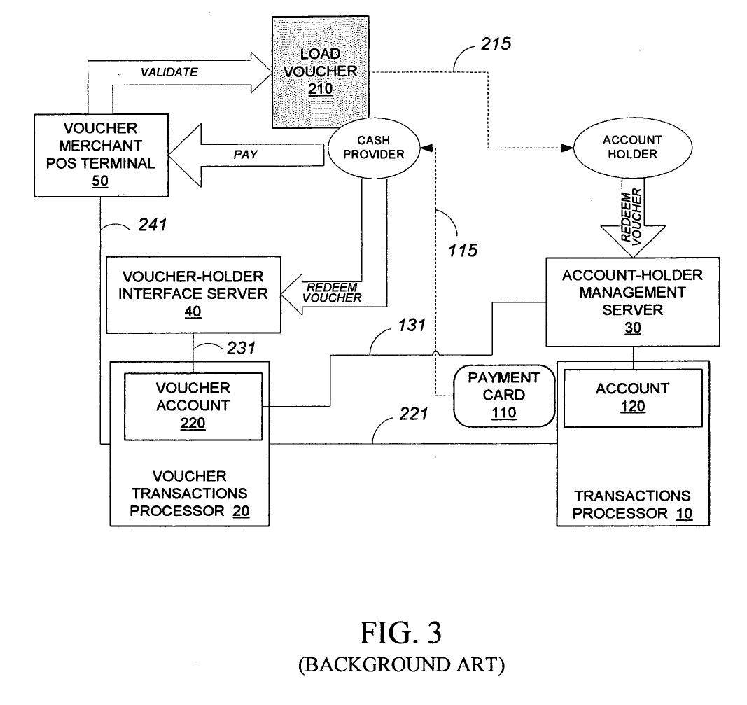

### DETAILED DESCRIPTION OF THE INVENTION

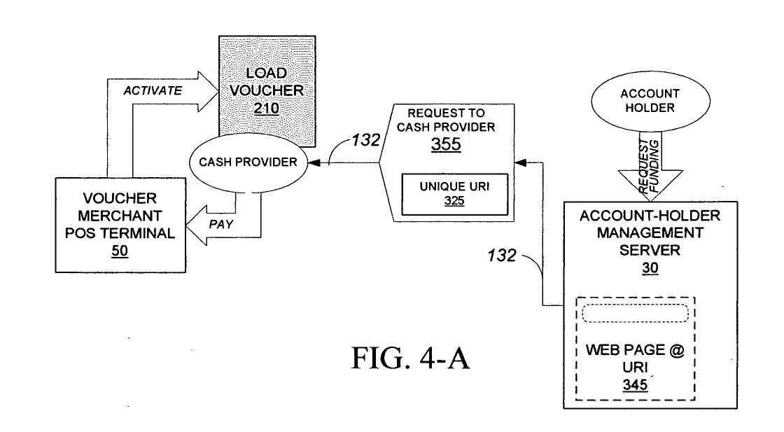

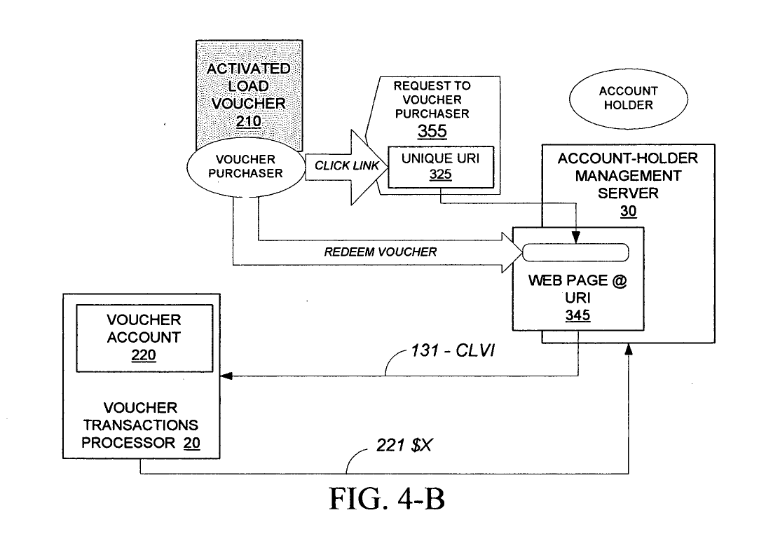

Reference if made to FIG. 4-A which schematically describes a funding request method according to a first preferred embodiment of the present invention. A user has a monetary current account of the prior art (not shown), which user can access online via account-holder management server 30. Online access may be via a consumer terminal such as a personal computer, a mobile phone, or a tablet connected via a public network such as the Internet. Once authenticated by the server 30, the user can initiate a funding request with the intention to obtain the loading of funds into his or her account from a remote cash provider. A typical funding request contains at least a means of communicating with the intended cash provider, such as, by way of example, an email address and/or a mobile phone number of the background art.

Optionally, the funding request may contain the amount of money $X solicited from the cash provider.

Upon receiving such funding request from the user, the account management server 30 generates a unique Uniform Resource Identifier (URI) 325 derived from the identity of the user account to be funded. The URI can be generated by any one-way function of the background art with sufficient security. A one-way function is a mathematical transformation which is computationally hard to invert, meaning that the identity of the user account to be funded cannot easily be derived from the value of the URI.

For further security, the URI can also be optionally derived from a sequence number or a time-derived number, or a pseudo-random number generator, to ensure that the URI is unique, and that several requests from the same account will reset in different URIs.

According to a preferred embodiment of the present invention, the URI is a Uniform Resource Locator as used in Internet communications, i.e. an address at which a World Wide Web page can be found by simply typing the URL in the address field of a browser of the background art. The URI 325 is transmitted to the prospective cash provider in an electronic message 355. The electronic message may be transmitted by any electronic transmission means of the background art, such as e-mail or mobile text messages known as SMS.

Concurrently with the sending of message 355, the account-holder manager server 30 generates a web-displayable page 345 using encoding of the background art such as hypertext markup language (html) and places the page at the address designated by URI 325.

Some amount of time after having received the electronic message 355 containing the funding solicitation, the cash provider can buy and activate a Cash Load Voucher 210 of the background art at a suitable retail location. The Cash Load Voucher is rendered activated at the Point of Sale Terminal 50 of the retail location upon a procedure of the background art specific to the vendor of Vouchers (not shown), such procedure including at least the remittance of cash to the operator of the Terminal.

Reference is made to FIG. 4-B which schematically describes the resulting loading of funds into the account according to a first preferred embodiment of the present invention. The cash provider is now in possession of an activated Load Voucher 210 with a value determined by the amount of cash remitted to the operator of Terminal 50.

The cash provider uses the URI 325 received in the electronic message 355 to locate the Internet page 345 generated by the server 30.

The page 345 contains a redemption field into which the cash provider can input the Identifier of the activated Cash Load Voucher. The format of the Identifier is determined by the vendor of Vouchers of the background art. By way of example, a Cash Load Voucher Identifier (CLVI) is typically a long number.

The CLVI is transmitted electronically by server 30 to a voucher transactions processor computer server 20 typically operated by the operator of the voucher system of the background art. The method and format of transmission 131 of the CLVI data between server 30 and server 20 are outside of the scope of the present invention and are defined by the operator of server 20. Upon reception of the CLVI, the voucher transaction processor 20 confirms that the corresponding voucher is valid and has been activated for an amount of $X.

Server 30 will then instruct the account processor (not shown) to increment the balance of the designated account by $X. The method and format of communication between the account-holder server and the account processor are outside the scope of this invention.

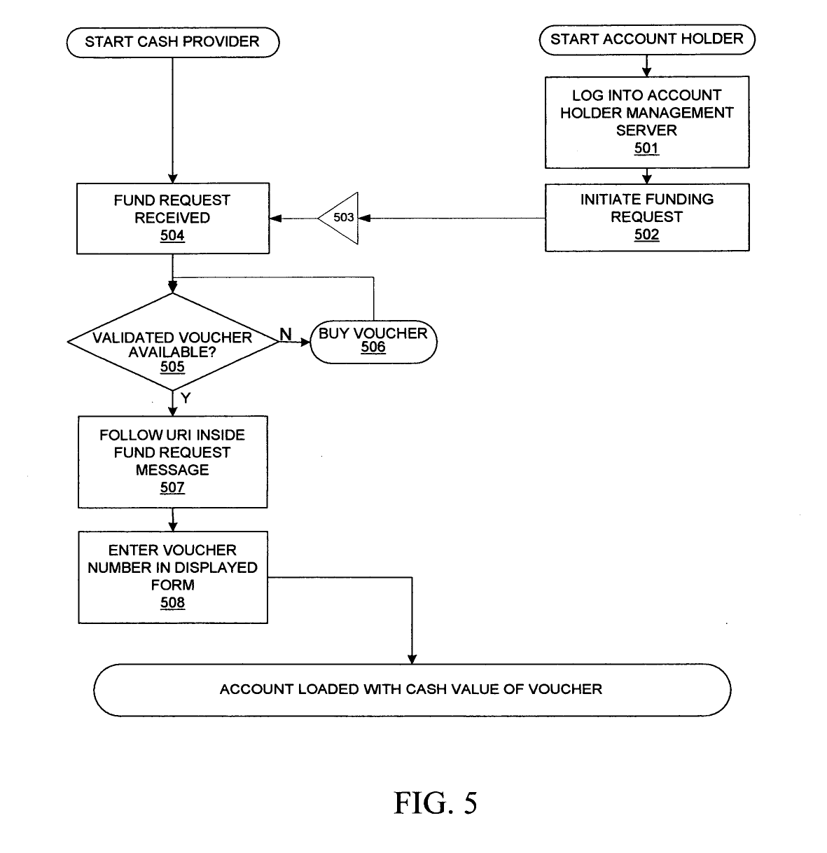

Reference is made to FIG. 5 which schematically describes the flow chart of the remote funding steps performed by the account holder and the cash provider according to a first preferred embodiment of the present invention.

In step 501, the account holder logs into his or her current account online.

In step 502, the account holder initiates a funding request by specifying the name and an electronic address of the intended cash provider, and optionally the amount $X of desired funding.

The resulting funding request message is generated as step 503 and is sent via electronic transmission means of the background art such as email or mobile messaging.

In step 504, the electronic message of step 503 is received and read by the cash provider.

In step 505, if the cash provider does not already have a valid Cash Load Voucher, he or she is invited to go and purchase one in step 506 for $Y where $Y can be either exactly the requested amount $X or a higher amount $Y=$X+$F where F is a fee determined by the operator of the voucher system to compensate the operator of the activation terminal 50 of FIG. 4.

In step 507, the cash provider retrieves the URI inside the message sent in the earlier step 503 and links over to the page 345 of FIG. 4-B

In step 508, the cash provider enters the Cash Load Voucher Identifier of the activated Load Voucher purchased in step 506.

This results in the account being credited by $X, after the servers 20 and 30 of FIG. 4-B have completed their interaction.

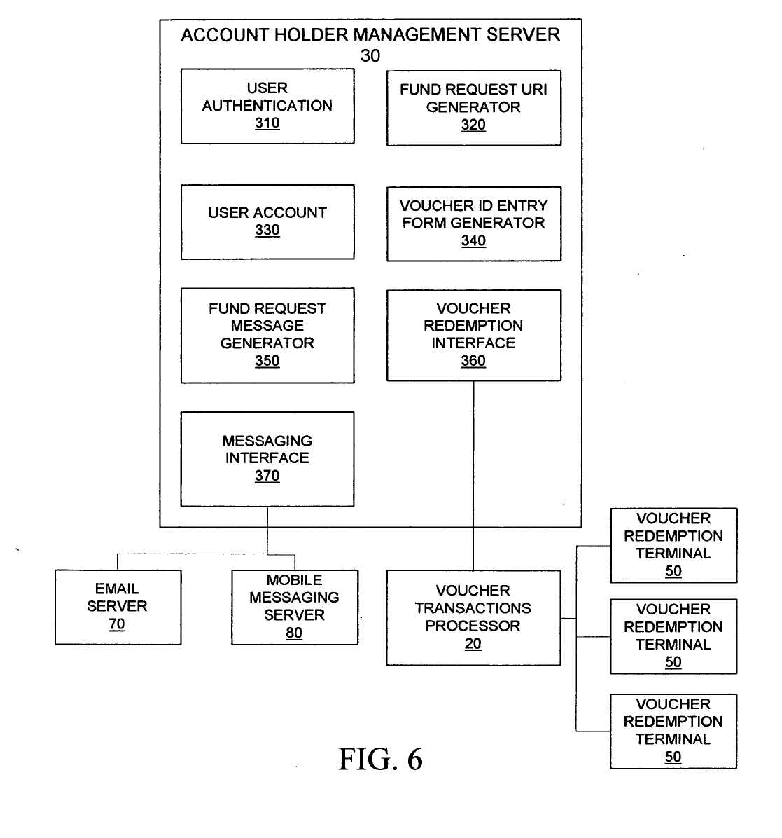

Reference is made to FIG. 6 which schematically describes a set of computer servers and electronic communication links according to a first preferred embodiment of the present invention.

Account-holder management server 30 contains and operates a user authentication module 310, a URI generator 320, a user account 330, a generator of CLVI online entry forms 340, a funding requests electronic message generator 350, a voucher redemption interface module 360, and a messaging interface 370.

External computer systems of the background art 70 and 80 perform the transmission of electronic messages generated by server 30, respectively via email and mobile messaging.

Servers 70 and 80 and their respective electronic communication protocols are outside the scope of the present invention.

Server 30 also interfaces with computer server 20 of the background art, operated by the processor of the voucher system, which interfaces in turn with a multiplicity of Point Of Sale terminals 50 located at the retail shops where vouchers can be purchases. Server 20 and Terminals 50 and their respective electronic communication protocols are outside the scope of the present invention.

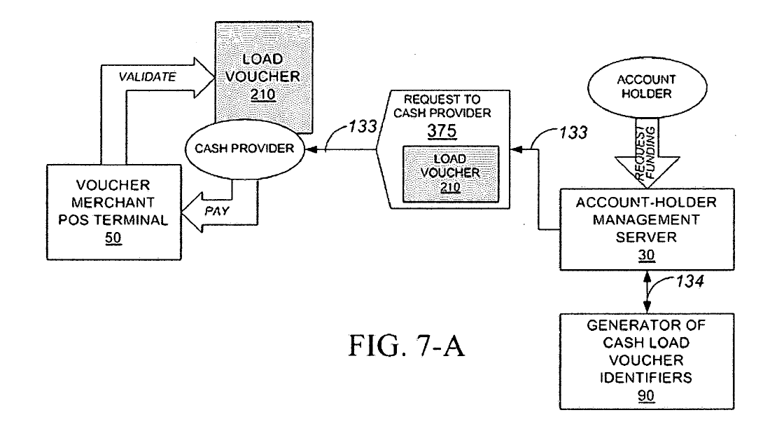

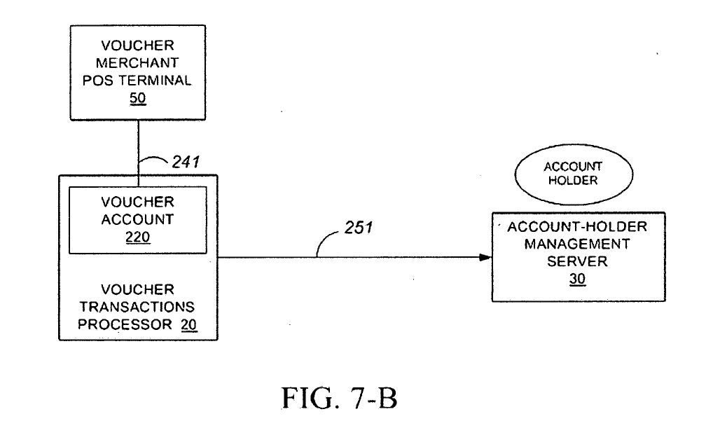

Reference if made to FIG. 7-A which schematically describes a funding request method according to a second preferred embodiment of the present invention. A user has a monetary current account of the prior art (not shown), which user can access online via account-holder management server 30. Online access may be via a consumer terminal such as a personal computer, a mobile phone, or a tablet connected via a public network such as the Internet. Once authenticated by the server 30, the user can initiate a funding request with the intention to obtain the loading of funds into his or her account from a remote cash provider. A typical funding request contains at least a means of communicating with the intended cash provider, such as, by way of example, an email address and/or a mobile phone number of the background art.

Optionally, the funding request may contain the amount of money $X solicited from the cash provider.

According to a preferred embodiment of the present invention, upon receiving such funding request from the user, the account-holder management server 30 assembles an electronic message to seek a unique Cash Load Voucher Identifier (CLVI) data string from a computer server 90 typically operated by a voucher issuing company of the background art. In response to the CLVI request issued by account-holder server 30, the CLVI generator server 90 delivers a CLVI data string uniquely related to the account-holder seeking the remote funding. The electronic communication protocol 134 between server 30 and server 90 is outside of the scope of the present invention and may be any existing communication protocol of the background art determined by the voucher issuing company operating the server 90.

According to another preferred embodiment of the present invention, the account-holder server 30 associates a unique CLVI data string to the account-holder funding request by choosing one data string among a collection of CLVIs received beforehand from the CLVI generator server 90 during a batch transmission of a plurality of CLVIs.

The method for associating a CLVI to a particular account-holder funding request is outside of the scope of the present invention and may be any known method of the prior art, such as pseudo-random pairing or one-way mathematical functions. The present invention can support both re-usable CLVIs derived only from the identity of the requesting account, or one-time-use CLVIs which are derived from both the identity of the requesting account and a specific funding request from the account-holder.

Account-holder server 30 generates a Cash Load Voucher 210 from said CLVI and inserts it inside an electronic message 375 destined to the remote cash funder. The electronic message 375 may be transmitted by any electronic transmission means of the background art, such as e-mail or mobile text messages known as SMS.

Some amount of time after having received the electronic message 375 containing the Cash Load Voucher 210, the cash provider can activate said Cash Load Voucher 210 at a suitable retail location. The Cash Load Voucher is rendered activated at the Point of Sale Terminal 50 of the retail location upon a procedure of the background art specific to the issuer of Vouchers (not shown), such procedure including at least the remittance of cash to the operator of the Terminal. Depending on the policies of the operator of the voucher system, the amount of cash to be remitted by the cash provider may be either exactly $X or the sum of $X+$F where F is a fee to be paid by the cash provider to compensate the operator of Terminal 50 and the operator of the voucher service.

Reference is made to FIG. 7-B which schematically describes the resulting loading of funds into the account according to a second preferred embodiment of the present invention. The Terminal 50 assembles an electronic message 214 confirming that the CLVI associated with the activated voucher 210 corresponds to the remitted amount of $X, and transmits said message 241 to a voucher transactions processor computer server 20 typically operated by the operator of the voucher system of the background art. The method and format of transmission of electronic message 241 of the activated CLVI data between Terminal 50 and server 20 are outside of the scope of the present invention and are typically defined by the operator of server 20.

The server 20 communicates back to the account-holder management server 30 the confirmation that the CLVI was redeemed for the amount of $X in an electronic message 251. The method and format of transmission of electronic message 251 between server 20 and server 30 are outside of the scope of the present invention and are typically defined by the operator of server 20.

Server 30 will then instruct the account processor (not shown) to increment the balance of the designated account by $X. The method and format of communication between the account-holder server and the account processor are outside the scope of this invention.

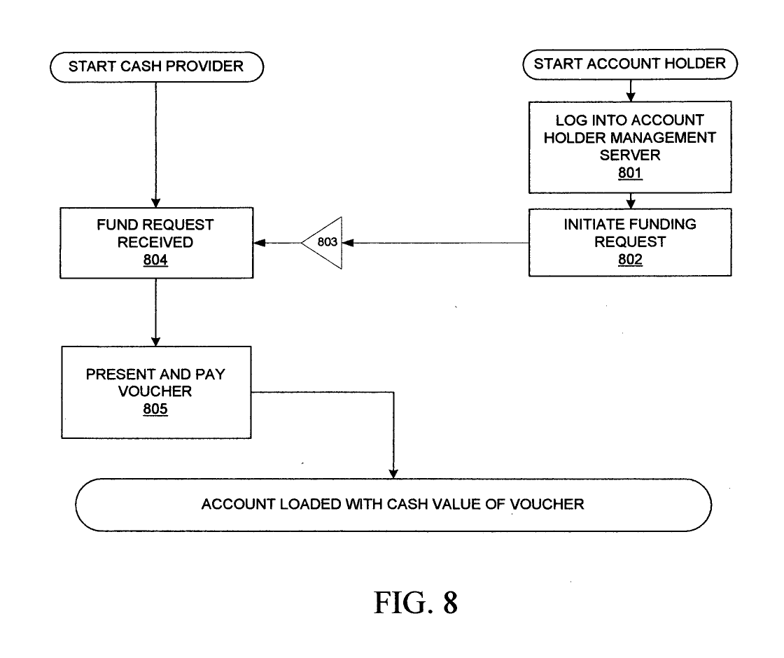

Reference is made to FIG. 8 which schematically describes the flow chart of the remote funding steps performed by the account holder and the cash provider according to a second preferred embodiment of the present invention.

In step 801, the account holder logs into his or her current account online.

In step 802, the account holder initiates a funding request by specifying the name and an electronic address of the intended cash provider, and optionally the amount $X of desired funding.

The resulting funding request message is generated as step 803 and is sent via electronic transmission means of the background art such as email or mobile messaging.

In step 804, the electronic message of step 803 is received and read by the cash provider.

In step 805, the cash provider presents the Cash Load Voucher to a suitable location and remits $Y where $Y can be either exactly the requested amount $X or a higher amount $Y=$X+$F where F is a fee determined by the operator of the voucher system to compensate the operator of the activation terminal 50 of FIG. 7.

This results in the account being credited by $X, after the servers 20 and 30 of FIG. 7-B have completed their interaction.

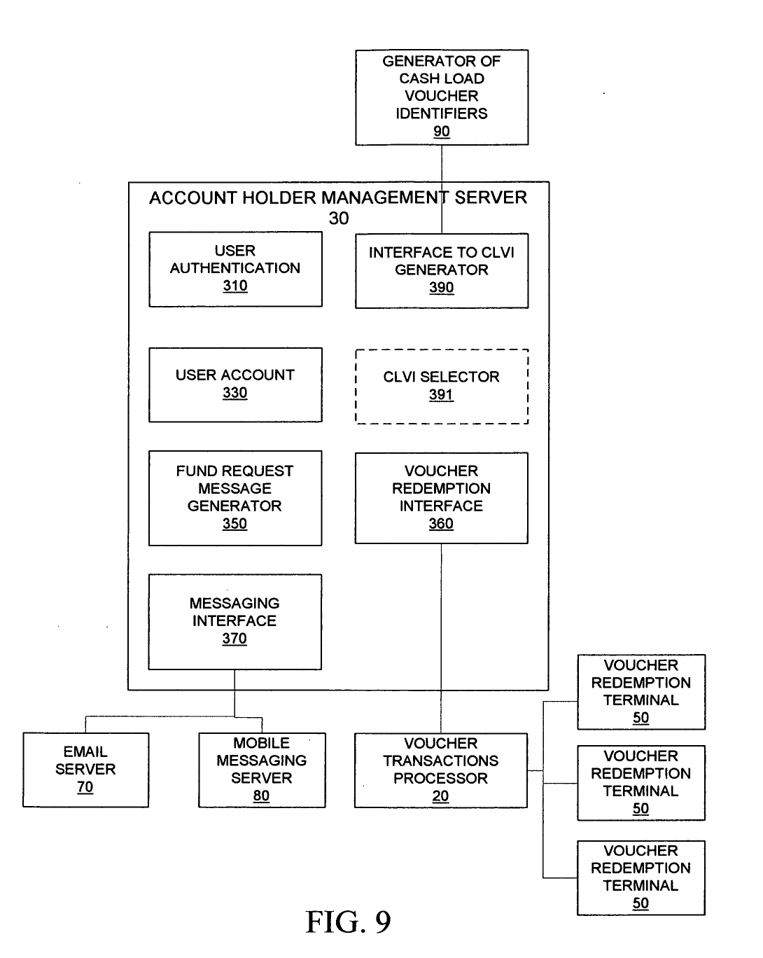

Reference is made to FIG. 9 which schematically describes a set of computer servers and electronic communication links according to a second preferred embodiment of the present invention.

Account-holder management server 30 contains and operates a user authentication module 310, an interface module 390 to a CLVI generator, an optional CLVI selector module 391, a user account 330, a funding requests electronic message generator 350, a voucher redemption interface module 360, and a messaging interface 370.

External computer systems of the background art 70 and 80 perform the transmission of electronic messages generated by server 30, respectively via email and mobile messaging.

Servers 70 and 80 and their respective electronic communication protocols are outside the scope of the present invention.

Server 30 interfaces with computer server 90 of the background art, operated by the processor of the voucher system, to generate valid CLVIs to be used in the generation of Cash Load Vouchers. In one possible embodiment of the present invention where server 90 generates a series of CLVIs and delivers them in batches to server 30, then the CLVI selector module 391 is used to select a CLVI for each account-holder requesting funding or for each specific funding request, depending on whether CLVIs are re-usable or not for multiple funding requests.

Server 30 also interfaces with computer server 20 of the background art, operated by the processor of the voucher system, which interfaces in turn with a multiplicity of Point Of Sale terminals 50 located at the retail shops where vouchers can be purchases. Server 20 and Terminals 50 and their respective electronic communication protocols are outside the scope of the present invention.

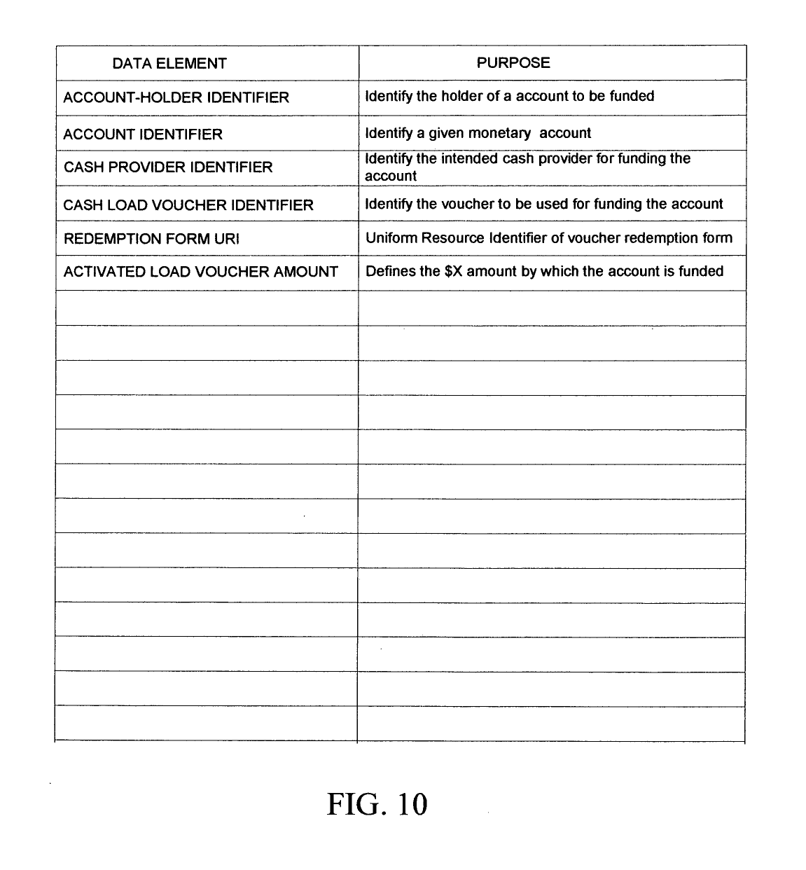

Reference if made to FIG. 10 which lists the main data elements exchanged between computer servers according to preferred embodiments of the present invention.

The ACCOUNT HOLDER IDENTIFIER data element is used to uniquely identify the holder of a current monetary account who may request remote funding of his/her account. It is typically a single alphanumeric string.

The ACCOUNT IDENTIFIER data element identifies a specific monetary account assigned to an account holder. It is typically a single alphanumeric string.

The CASH PROVIDER IDENTIFIER data element is used to identify and communicate with the intended provider of cash in a remote funding transaction. It is typically a plurality of alphanumeric strings, including the name of the cash provider, his or her email address, his or her phone number.

The CASH LOAD VOUCHER IDENTIFIER (CLVI) is used to identify the Load Voucher to be presented at a suitable location together with the remittance of cash by the cash provider. It is typically a single alphanumeric string.

The REDEMPTION FORM URI is used to locate the online-accessible electronic form where the CLVI of an activated voucher can be entered by the cash provider according to a first preferred embodiment of the present invention. It is typically a single alphanumeric string formatted as a Uniform Resource Locator (URL) commonly used in Internet protocols.

The ACTIVATE LOAD VOUCHER AMOUNT $X is the amount of funds by which the requesting account will be incremented. This is typically a single numeric string.

While the invention has been described with respect to a limited number of embodiments, it will be appreciated by persons skilled in the art that the present invention is not limited by what has been particularly shown and described herein. Rather the scope of the present invention includes both combinations and sub-combinations of the various features described herein, as well as variations and modifications which would occur to persons skilled in the art upon reading the specification and which are not in the prior art.

What is claimed is:

1. A funding method between a monetary account holder and a remote cash provider based on compiling a Uniform Resource Identifier (URI) being the result of a one-way function using said monetary account as an input parameter, compiling a data entry form addressable at said URI on a public computer network, compiling an electronic message containing said URI, sending said message by ordinary telecommunication means to a prospective cash provider, accepting card load voucher identifier data entered by the cash provider in the data entry form displayed at the URI retrieved by the cash provider inside the electronic message, and causing the cash value of the voucher to be loaded into the account of the accountholder upon successful entry of the voucher identifier in said entry form.

2. The funding method of claim [0001] wherein the monetary account is a prepaid payment card account.

3. The funding method of claim [0001] wherein the Uniform Resource Identifier is a world wide web Uniform Resource Locator which can be rendered as a clickable link inside an electronic mail message or mobile message such as a Short Message Service text message.

4. The funding method of claim [0001] wherein the URI is compiled from the identifier or the monetary account and a unique sequence number in order to be usable only once.

5. A computer server apparatus combining (a) a user authentication module capable of authenticating the holder of a monetary account, (b) a URI generation module capable of generating URI data strings as a function of account identifiers, (c) a data entry form generation module capable of producing the computer code needed for displaying entry forms for entering voucher identifier numbers, located at the URIs generated by the URI generation module, (d) an electronic message generation module capable of assembling messages including URIs generated by the URI generation module, (e) an interface to external messaging servers for sending the assembled electronic messages to third parties, (f) a voucher redemption interface module, for forwarding voucher identifiers captured in the data entry forms to a voucher transactions processor.

6. A funding method between a monetary account holder and a remote cash provider based on associating a Cash Load Voucher Identifier (CLVI) with said monetary account, compiling an electronic message containing said CLVI data, sending said message by ordinary telecommunication means to a prospective cash provider, inviting the cash provider to bring a paper or electronic display copy of said CLVI to a location equipped with specially programmed Cash Load Voucher Redemption Terminal, and causing the cash value of the Voucher to be loaded into the account of the accountholder upon successful redemption of the Cash Load Voucher at said Redemption Terminal.

7. The funding method of claim [0006] wherein the monetary account is a prepaid payment card account.

8. The funding method of claim [0006] wherein the Cash Load Voucher Identifier is derived programmatically from a unique identifier or the monetary account and a unique sequence number in order to be usable only once by the remote cash provider.

9. The funding method of claim [0006] where the Cash Load Voucher Identifier is associated only with a unique identifier of the monetary account in order to be reusable by the remote cash provider a plurality of times to fund the same account.

10. A computer server apparatus combining (a) a user authentication module capable of authenticating the holder of a monetary, (b) an interface module to an external Cash Load Voucher Identifier generation module capable of generating CLVI data strings as a function of account identifiers, (c) an electronic message generation module capable of assembling messages including CLVI data generated by the CLVI generation module, (d) an interface to external messaging servers for sending the assembled electronic messages to third parties, (e) a plurality of Cash Load Voucher Redemption Terminals capable of verifying the validity of CLVI data presented to them and declaring the corresponding Cash Load Voucher redeemed when cash in sufficient amount if delivered to the operator of the terminal (f) a voucher redemption interface module, capable of interpreting electronic messages received from a plurality of Cash Load Voucher Redemption Terminals located at external locations and each capable of verifying the validity of CLVI data presented to them and declaring the corresponding Cash Load Voucher redeemed when cash in sufficient amount is delivered to the operator of said Terminal.
